(19) United States
(12) Patent Application Publication
(10) Pub. No.: US 2023/0235890 A1
(43) Pub. Date: Jul. 27, 2023

(54) APPLIANCES WITH A MOBILE USER INTERFACE

(71) Applicant: Haier US Appliance Solutions, Inc., Wilmington, DE (US)

(72) Inventors: Kenneth Willard Johnson, Ringgold, GA (US); Frank Jacob Hellwig, East Ridge, TN (US); David L. Brown, Chattanooga, TN (US)

(21) Appl. No.: 17/581,325

(22) Filed: Jan. 21, 2022

(51) Int. Cl. F24C 7/08; F24C 3/12; G06F 1/16; G06F 3/16

(52) U.S. Cl. CPC F24C 7/082; F24C 3/124; G06F 1/1626; G06F 3/167

(57) ABSTRACT

A cooking appliance that includes a heating element, a controller, and a dock, each mounted to a panel. The cooking appliance also includes a user interface which is removably mountable to the panel, so that the user interface can be used separated from the cooking appliance. The controller is configured for detecting a proximity of the user interface relative to the panel. Further, the controller is configured for deactivating the heating element in response to the detected proximity of the user interface relative to the panel passing a deactivation threshold.

### FIELD OF THE INVENTION

The present subject matter relates generally to user interfaces for controlling appliances.

### BACKGROUND OF THE INVENTION

While preparing a meal on a cooktop, users may need to be at another work area in a kitchen to prepare another portion of the meal. If the cooktop starts burning or overboiling the meal on the cooktop, the user must rush back to the cooktop and turn down or deactivate the heating element. If the user does not adjust the heating elements in time, a mess can be made requiring the user to postpone cooking to clean the cooktop.

Commonly, cooktops have integrated controls, such as control knobs, that stick out from the cooktop effecting a few different aspects of the cooktop's operation. The controls can contain bezels, embossments, or other obstruction. Moreover, conventional cooktop controls are limited to a fixed configuration that offers limitations on precision cooking and customizability. The conventional cooktop controls are bound by a user interface footprint on the cooktop, and a cooktop's usable cooktop space is delimited by the user interface footprint.

### BRIEF DESCRIPTION OF THE INVENTION

Aspects and advantages of the invention will be set forth in part in the following description, or may be apparent from the description, or may be learned through practice of the invention.

In one example embodiment, a cooking appliance includes a panel and a heating element mounted to the panel. Also, a controller is mounted to the panel, and the controller is in operative communication with the heating element. The cooking appliance also includes a user interface which is removably mountable to the panel. The user interface and the controller are configured for two-way communication such that data corresponding to the operation of the cooking appliance is transmittable to and receivable by the user interface. The cooking appliance further includes a dock mounted to the panel. The dock is configured for charging the user interface when the user interface is mounted to the dock on the panel. The user interface is operably configured to transmit and receive the data corresponding to operating the cooking appliance both while the user interface is mounted to the dock and while the user interface is removed from the dock. The controller is configured for detecting a proximity of the user interface relative to the panel. The detected proximity comprising one of a plurality of thresholds. The controller is further configured for deactivating the heating element in response to the detected proximity of the user interface relative to the panel passing a deactivation threshold of the plurality of thresholds.

In another example embodiment, a method of operating an appliance that includes connecting a user interface to a dock on the appliance to adjust the settings of the appliance. The method also includes removing the user interface from the dock and retaining the ability to adjust the settings of the appliance. Further, operating the appliance from the user interface within a plurality of thresholds detected by the user interface, while the user interface is removed from the appliance.

An appliance includes a panel and a controller mounted to the panel. There is a user interface removably mountable to the panel, and the user interface and the controller are configured for two-way communication such that data corresponding to operation of the appliance is transmittable to and receivable by the user interface. The appliance also includes a dock mounted to the panel. The dock is configured for charging the user interface when the user interface is mounted to the dock on the panel. The user interface is operably configured to transmit and receive the data corresponding to operating the appliance both while the user interface is mounted to the dock, or the user interface is removed from the dock.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a cooktop appliance with a removable user interface according to an example embodiment of the present disclosure.

FIG. 2 is a schematic view of the example cooktop appliance and removable user interface of FIG. 1.

FIG. 3 is a schematic view of certain components of the example cooktop appliance of FIG. 1.

FIG. 4 is a perspective view of the example cooktop appliance of FIG. 1 shown within an example building and user proximity detection ranges for the removable user interface.

FIG. 5 is a flowchart of a method according to an example embodiment of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

Referring now to the figures, an example user interface 106 will be described in accordance with example aspects of the present subject matter. The present disclosure relates generally to a user interface 106 for a cooktop appliance 100. Although cooktop appliance 100 is used below for the purpose of explaining the details of the present subject matter, it will be appreciated that the present subject matter may be used in or with any other suitable appliance in alternative example embodiments. For example, the user interface 106 described below may be used on other types of cooktop appliances, such as single or double oven range appliances. Additionally, user interface 106 may also be configured for controlling non-cooking appliances within a building, e.g., a washing machine appliance, a dryer appliance, a refrigerator appliance, a ventilation hood, etc. Further, user interface 106 may be configured to operate a camera, which may provide visual communication of cooking preparation status. The camera may be either integrated within the user interface 106 or separately remotely mounted. For example, the camera may be mounted above a cooktop appliance 100 to provide a view of the cooktop while the user may be operating the cooktop appliance 100 remotely. Cooktop appliance 100 is used in the discussion below only for the purpose of explanation, and such use is not intended to limit the scope of the present disclosure to any particular style of appliance.

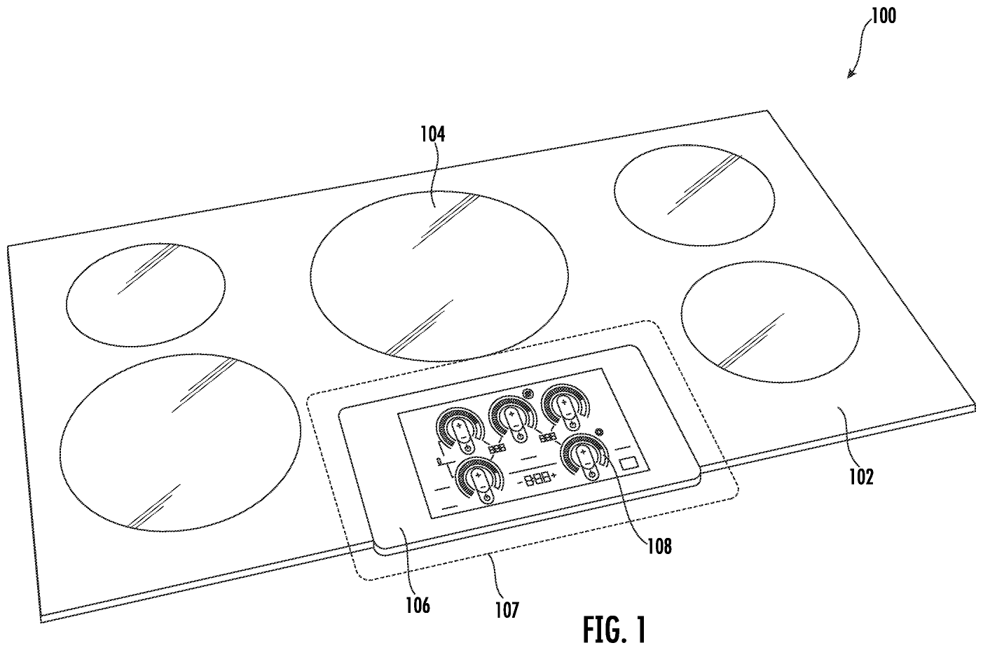

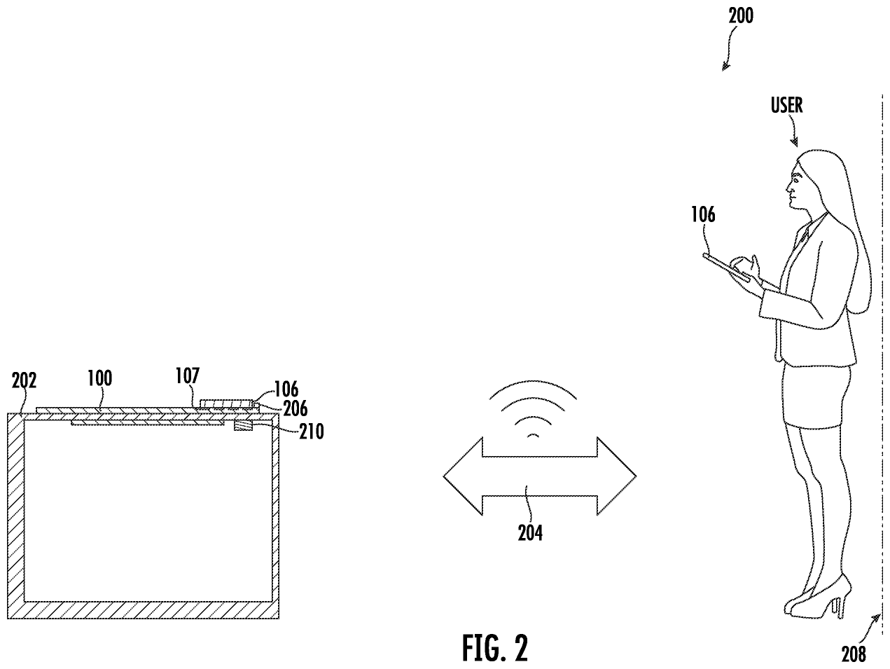

FIG. 1 illustrates an example embodiment of a cooktop appliance 100 of the present disclosure. Cooktop appliance 100 may be, e.g., fitted integrally with a surface of a kitchen counter 202 (FIG. 2) or may be configured as a slide-in cooktop unit. Cooktop appliance 100 includes a top panel 102 that includes one or more heating sources, such as heating element 104 for use in, e.g., heating or cooking. In general, top panel 102 may be constructed of any suitably rigid material capable of supporting heating element 104, cooking utensils, and/or other components of cooktop appliance 100. By way of example, top panel 102 may be constructed of glass, ceramics, brass, aluminum, combinations thereof, or any other suitable heat resilient material.

According to the illustrated example embodiment, a user interface 106 may be located within convenient reach of a user of cooktop appliance 100. In example embodiments, user interface 106 may be a tablet computing device. The user interface 106 may have a high-definition screen, such as a liquid crystal display (LCD) screen or similar types, and may include a touch screen interface. In one example embodiment, a tablet as user interface 106 may be mounted on a dock 107 of the cooktop appliance 100. The dock 107 may have a magnetically active section, e.g., with one or more magnets, to align the user interface 106 on the dock 107. Additionally, dock 107 may have a recharging element, such as an induction charger, to provide power to the user interface 106 through wireless charging. Further, dock 107 may also include a heating element 104. The heating element 104 in dock 107 may be an additional heating element on the cooktop, but still configured to operate similar to heating element 104. Heating element 104 in dock 107 may be restricted from operating when the user interface 106 is mounted on the dock 107. The heating element 104 in dock 107 may be positioned directly below user interface 106 when the user interface 106 is mounted on the dock 107.

On the user interface 106, control inputs 108, such as virtual knobs, allow the user to activate each heating element 104 and regulate the amount of heat input each heating element 104 provides to a cooking utensil located thereon, as described in more detail below. Although user interface 106 of cooktop appliance 100 is illustrated as including a configuration of control inputs 108 for controlling heating element 104, it will be understood that the configuration of control inputs 108 of cooktop appliance 100 shown in FIG. 1 is provided by way of example only. More specifically, user interface 106 may include various input configurations, such as one or more of a variety of touch-type controls, e.g., buttons, sliders, knobs, bars, etc.

Cooktop appliance 100 as shown may generally be referred to as an “electric cooktop.” However, it should be appreciated that cooktop appliance 100 is being shown for example purposes only. One or more of the heating elements 104 in cooktop appliance 100 may be an induction heating element, a resistive heating element, or a gas burner heating element. For example, cooktop appliance 100 may utilize a gas burner as the heating elements 104. As illustrated, heating element 104 may be positioned within top panel 102 and have various sizes, as shown in FIG. 1, so as to provide for the receipt of cooking utensils (i.e., pots, pans, etc.) of various sizes and configurations and to provide different heat inputs for such cooking utensils. It should be appreciated that in an example embodiment where the cooktop includes induction heating elements, the cooking utensils may be comprised of any suitable ferromagnetic material. As an example, in one example embodiment, the cookware item may be comprised of iron (Fe). In another exemplary embodiment, the cookware item may be comprised of nickel (Ni). In yet another alternative exemplary embodiment, the cookware item may be comprised of cobalt (Co). It should also be appreciated, however, that the cookware item may be comprised of any suitable alloys of iron (Fe), nickel (Ni), or cobalt (Co).

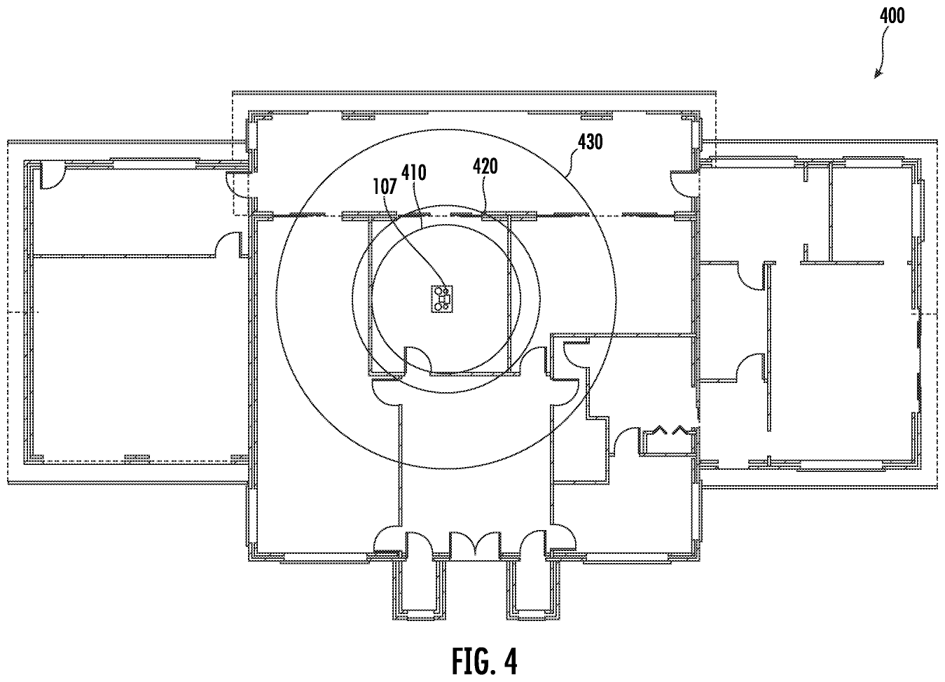

As shown in FIG. 2, a perspective view communication system 200. In one example embodiment, the cooktop appliance 100 may be fully integrated into a kitchen counter 202. The user interface 106 is shown in two alternative locations: (1) mounted on the dock 107; and (2) removed from the dock 107 by a user. Thus, user interface 106 is removable from cooktop appliance 100, e.g., while still allowing user interface 106 to wirelessly input control commands to cooktop appliance 100. The user interface 106 can be used with complete functionality within boundary 208, as further explained in the context of FIG. 4 below, because of two-way connectivity 204 between the user interface 106 and a controller 210. In general, the two-way connectivity 204 between user interface 106 and controller 210, may be carried using any type of wired or wireless connection and using any suitable type of communication network, non-limiting examples of which are provided below. For example, the communication network may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL). In an example embodiment, the user interface 106 and controller 210 may connect through the internet, enabling the ability for an appliance manufacturer to conduct system diagnostics and system updates, remotely.

Two-way connectivity 204 is described herein according to an example embodiment of the present subject matter. However, it should be appreciated that the example functions and configurations of the two-way connectivity 204 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Further shown in FIG. 2, on the under-side of cooktop appliance 100 may controller 210. On the topside of cooking appliance 100 may be an emergency stop switch 206. Emergency stop switch 206 is a manually operated switch for the immediate deactivation of the heating element 104. For instance, if the user interface 106 is broken, damaged, lost, etc., and the heating element 104 is still active, the emergency stop switch 206 provides a failsafe for deactivating the heating element 104.

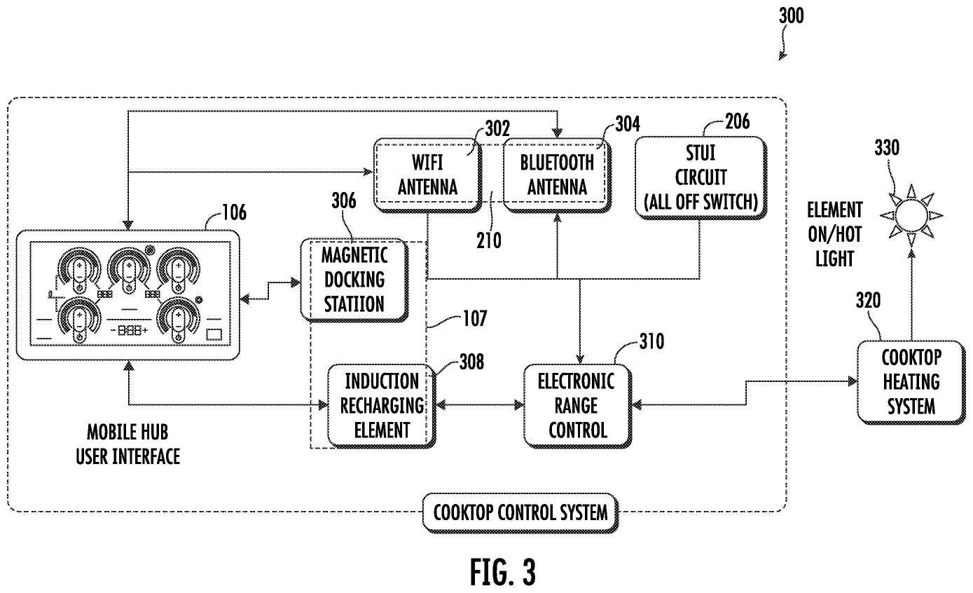

FIG. 3 illustrates a schematic view of cooktop control system 300. The user interface 106 is shown connected to four other components: a Wi-Fi antenna 302; a Bluetooth antenna 304, the magnetic docking station 306, and an induction recharging element 308. The Wi-Fi antenna 302 and Bluetooth antenna 304 may both be integrated within and/or in signal communication with controller 210. The induction recharging element 308 along with the magnetic docking station 306 may integrated within the dock 107. As shown by the flowchart arrows of FIG. 3, starting from user interface 106, the user may choose to control the electronic range control 310 of cooktop appliance 100, by either mounting the user interface 106 to dock 107 or with the user interface 106 removed from dock 107 such that the user interface 106 communicates through the Wi-Fi antenna 302 or the Bluetooth antenna 304 with controller 210. As shown, the electronic range control 310 operates the cooktop heating system 320, which when activated, activates an element on/hot light 330 as well as the respective heating element 104. For example, in one example embodiment, cooktop control system 300 is operable with user interface 106 magnetically connected to the dock 107, where the user interface 106 is recharging through an induction recharging element. Through the dock 107, the user interface 106 communicates with the electronic range control 310 to operate the cooktop heating system 320. When the cooktop heating system 320 is activated, the element on/hot light 330 is simultaneously or subsequently activated along with the respective heating element 104. In another example embodiment, cooktop control system 300 is operable with the user interface 106, removed from the dock 107, communicating with the controller 210. Through controller 210, the user interface 106 communicates with the electronic range control 310 to operate the cooktop heating system 320. When the cooktop heating system 320 is activated, the element on/hot light 330 is simultaneously or subsequently activated along with the respective heating element 104. In both of these example embodiments, cooktop heating system 320 includes one or more of the heating elements 104. Additionally in each example embodiment, a single touch user interface (STUI) circuit, or emergency stop switch 206 is in connection with the electronic range control 310, and can be used to deactivate the cooktop heating system 320.

FIG. 4 illustrates in one example embodiment, a proximity detection system 400, for detecting the distance that the user interface 106 is away from the cooktop appliance 100. Proximity detection system 400 may, in one example embodiment, be configured to detect when the user interface 106 passes boundary 208. Dock 107 is shown to provide a starting point of reference. On dock 207, the user interface 106 is connected to the cooktop appliance 100 and is a negligible distance away from the controller 210. The area defined between the dock 107 and the full operability threshold 410 may be the intended operation range. Full operability threshold 410 may be the furthest distance away from the cooktop appliance 100 that user interface 106 may be while retaining full control of the cooktop appliance 100. This may include the ability to turn on the heating element 104. Thus, e.g., while user interface 106 is within the full operability threshold 410, user interface 106 may fully activate, deactivate, and adjust heating elements 104.

The area defined by the full operability threshold 410 and a warning threshold 420 may be a warning range. In between the full operability and warning thresholds 410, 420, the user interface 106 may display a warning message. The warning message may include an audible tone alerting the user of the distance from the cooktop appliance 100 and the potential loss of functionality if the distance is further increased. The user interface 106 may have limited functionality in the warning range until the user interface 106 is returned to within the full operability threshold 410. For example, the user interface 106 may restrict the user from activating the heating element 104 while inside the warning range.

Further, the area defined by the warning threshold 420 and a deactivation threshold 430 may be a range of limited operability. In the limited operability range, the user interface 106 may have limited access to user inputs. For example, in the limited operability range, the user interface 106 may be too far away to activate the heating element 104. However, if the heating element 104 were already activated when the user interface 106 enters the limited operability range, the user may continue to monitor the cooktop appliance 100 with user interface 106. Deactivation threshold 430 may be the threshold where if crossed by the user interface 106, the cooktop appliance 100 will automatically deactivate the heating element 104. For example, if a toddler takes the user interface and runs off with the user interface 106, and the user interface 106 crosses the deactivation threshold 430, the cooktop appliance 100 will automatically deactivate the heating element 104. In general, one of skill in the art can appreciate that the proximity detection system 400 presented herein is one embodiment and is provided in such way for the purpose of example only. It should be appreciated that other configurations and modifications to size, shape, and arrangement may be made.

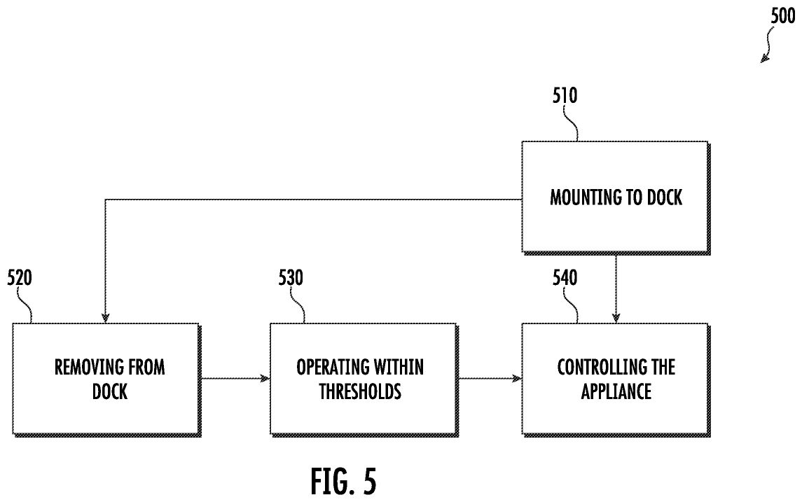

FIG. 5 illustrates a method 500 of operating an appliance with a user interface 106. The method 500 can be implemented to improve a user cooking experience. At 510, a user can mount the user interface 106 to a dock 107. For example, a user can place the user interface 106 onto the dock 107 on top of the cooktop appliance 100. From 510, a user can either control the cooktop appliance 100 at 540, or the user can remove the user interface 106 from the dock 107 at 520. By removing the appliance at 520, the user may still control the cooktop appliance 100 at 540, but must also stay within the operating thresholds 530. For example, a user removes the user interface 106 from the dock 520 and carries the user interface 106 to the countertop near the cooktop appliance 100 within full operability threshold 410, where the user can monitor and control the cooktop appliance 100 from the tablet 540. Next the user carries the user interface 106 out to the garage, where the user interface 106 has crossed the deactivation threshold 430, and the cooktop deactivates the heating element 104.

FIG. 5 depicts steps performed in a particular order for purposes of illustration and discussion. Those of ordinary skill in the art, using the disclosures provided herein, will understand that the steps of any of the methods discussed herein may be adapted, rearranged, expanded, omitted, or modified in various ways without deviating from the scope of the present disclosure. Moreover, although aspects of method 500 are explained using cooktop appliance 100 as an example, it should be appreciated that these methods may be applied to the operation of any suitable appliance.

As may be seen above, the present disclosure may be a system whereby a user interface 106 may mate, via a magnetic source or other mechanical sources, to a cooktop appliance 100 and communicate with cooktop appliance 100 through one or more wireless mediums. The user interface 106 may receive charging from an induction recharging element 308 integrated within the cooktop appliance 100. The user interface 106 may allow for input from a user as well as provide output to the user. The user interface 106 may use one or more methods to determine the distance between the user interface 106 and the cooktop appliance 100. The user interface 106 and the cooktop appliance 100 may have one or more distance thresholds where a threshold could alert the user with a warning that the user is getting close to terminating the cooking session. Another threshold may cause the cooking session to terminate, deactivate the heating elements 104, and alert the user of the termination. The user interface 106 may also interface with other compatible appliances and third-party applications, which may then allow the user interface 106 to act as a bridge between compatible appliances.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance, comprising:
a panel;
a heating element mounted to the panel;
a controller mounted to the panel, the controller in operative communication with the heating element;
a user interface removably mountable to the panel, the user interface and the controller configured for two-way communication such that data corresponding to operation of the cooking appliance is transmittable to and receivable by the user interface; and
a dock mounted to the panel, the dock configured for charging the user interface when the user interface is mounted to the dock on the panel,
wherein the user interface is operably configured for transmitting and receiving data corresponding to operating the cooking appliance both while the user interface is mounted to the dock and while the user interface is removed from the dock,
wherein the controller is configured for detecting a proximity of the user interface relative to the panel, the proximity comprising one of a plurality of thresholds, and
wherein the controller is further configured for deactivating the heating element in response to the proximity of the user interface relative to the panel passing a deactivation threshold of the plurality of thresholds.

2. The cooking appliance of claim 1, wherein the cooking appliance comprises one of a cooktop, a wall oven, and a range.

3. The cooking appliance of claim 1, wherein the heating element comprises one or more of an electric resistance heating element, a gas burner, and an induction heating element.

4. The cooking appliance of claim 1, wherein the user interface comprises a tablet.

5. The cooking appliance of claim 4, wherein the user interface comprises a liquid crystal display.

6. The cooking appliance of claim 4, wherein the user interface is configured for performing third party applications.

7. The cooking appliance of claim 1, wherein the user interface is configured for receiving audible user command inputs.

8. The cooking appliance of claim 1, wherein the dock comprises a magnetic positioner for the user interface.

9. The cooking appliance of claim 1, wherein the dock is positioned at an additional heating element mounted to the panel, wherein the additional heating element is operable when the user interface is not mounted to the dock.

10. The heating element of claim 9, wherein the heating element comprises an electric heating element.

11. The cooking appliance of claim 1, wherein the plurality of thresholds comprises a full operability threshold, wherein when the user interface is within the full operability threshold the user interface has access to all user inputs on the user interface.

12. The cooking appliance of claim 1, wherein the plurality of thresholds comprises a warning threshold, wherein when the user interface is within the warning threshold the user interface retains access to all user inputs on the user interface and a warning message is displayed to a user.

13. The cooking appliance of claim 12, wherein the plurality of thresholds comprises a limited operability threshold, which comprises limitations to the user interface functionality, wherein the user interface is beyond the warning threshold.

14. The cooking appliance of claim 13, further comprising restricting the user interface from activating the heating elements.

15. The cooking appliance of claim 1, wherein the user interface is beyond the deactivation threshold, which comprises restricting the user interface from user inputs.

16. A method of operating an appliance, comprising:
connecting a user interface to a dock on the appliance to adjust settings of the appliance; and
removing the user interface from the dock and retaining the ability to adjust settings of the appliance,
wherein operating the appliance from the user interface within a plurality of thresholds detected by the user interface while the user interface is removed from the appliance.

17. The method of claim 16, wherein the plurality of thresholds comprises a full operability threshold, wherein when the user interface is within the full operability threshold the user interface has access to all user inputs on the user interface.

18. The method of claim 16, wherein the plurality of thresholds comprises a warning threshold, wherein when the user interface is within the warning threshold the user interface retains access to all user inputs on the user interface and a warning message is displayed to a user;
wherein the plurality of thresholds further comprises a limited operability threshold, which comprises restricting the user interface from activating the appliance, wherein the user interface is beyond the warning threshold.

19. The method of claim 16, wherein the plurality of thresholds comprises a deactivation threshold, which comprises deactivating the appliance, wherein when the user interface is beyond the deactivation threshold comprises restricting the user interface from user inputs.

20. An appliance, comprising:
a panel;
a controller mounted to the panel;
a user interface removably mountable to the panel, the user interface and the controller configured for two-way communication such that data corresponding to operation of the appliance is transmittable to and receivable by the user interface;
a dock mounted to the panel, the dock configured for charging the user interface when the user interface is mounted to the dock on the panel; and
wherein the user interface is operably configured to transmit and receive data corresponding to operating the appliance both while the user interface is mounted to the dock and while the user interface is removed from the dock.
